(19) United States
(12) Patent Application Publication
(10) Pub. No.: US 2007/0229459 A1
(43) Pub. Date: Oct. 4, 2007

(54) Computer Peripheral Input Device

(76) Inventor: Pen-Ku Chang, Taipei (TW)

Correspondence Address: Heng-Yi Lin, 7F.-6, No. 17, Sec. 1, Chengde Rd., Taipei, 10351, omitted

(21) Appl. No.: 11/559,904

(22) Filed: Nov. 15, 2006

(30) Foreign Application Priority Data
Mar. 29, 2006 (TW) 095205221

(51) Int. Cl. G09G 5/08

(52) U.S. Cl. 345/163

(57) ABSTRACT

A computer peripheral input device is described. The computer peripheral input device includes a housing and a button. The housing is under a user's palm. The button, sideward positioned on the housing, is for the user to non-downward push with the user's index finger or middle finger.

### BACKGROUND OF THE INVENTION

(1) Field of Invention

This invention relates generally to an input device, and more particularly to a computer peripheral input device.

(2) Description of Related Art

FIG. 1 is a schematic view of a conventional mouse. Referring to FIG. 1, buttons 10 are positioned in front of a top surface of the mouse. A user's palm and fingers should be supported by using the user's wrist 20 and finger joints, for having suitable heights to press the buttons 10. The pressing step is performed from the top toward the bottom of the mouse. This pressing step easily injures the palm and the tendons of user's fingers, and may compress and then injure nerves of the fingers. In this pressing step, moreover, an extensive force may be generated from the fingers through the user's meridian to injure the user's arm and back. The above injuries, which are so-called “Carpal Tunnel Syndrome”, are problems of a conventional mouse that need to be overcome.

### SUMMARY

In one aspect of the present invention, a computer peripheral input device is provided. The computer peripheral input device may include a housing and a button. The housing may be under a user's palm. The button, sideward positioned on the housing, may be for the user to non-downward push with the user's index finger or middle finger.

In another aspect of the present invention, a method of using a computer mouse under a user's palm is described. The method may include a non-downward pressing step. In the non-downward pressing step, a button sideward positioned on the computer mouse with the user's index finger or middle finger.

### BRIEF DESCRIPTION OF THE DRAWINGS

FIG. 1 is a schematic view of a conventional mouse;

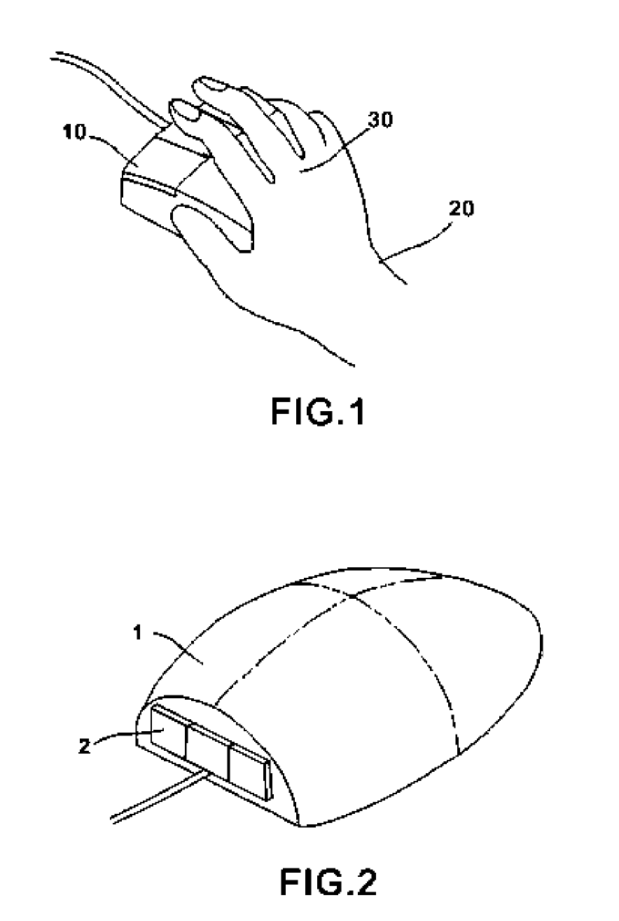

FIG. 2 is a schematic view of a computer mouse according to a third embodiment of the present invention;

FIG. 3 is a schematic view of a computer peripheral input device according to a second embodiment of the present invention; and

FIG. 4 is a side view of the computer peripheral input device of FIG. 3 according to the second embodiment of the present invention.

### DETAILED DESCRIPTION OF THE INVENTION

In a first preferred embodiment, the present invention may provide a method of using a computer mouse under a user's palm. The method may include a pressing step in which a button sideward positioned on the computer mouse is non-downward pressed with the user's index finger or middle finger. The non-downward pressing step may not be suggested by related arts.

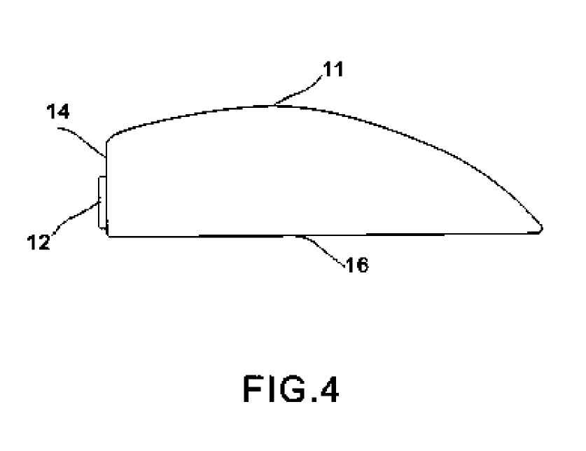

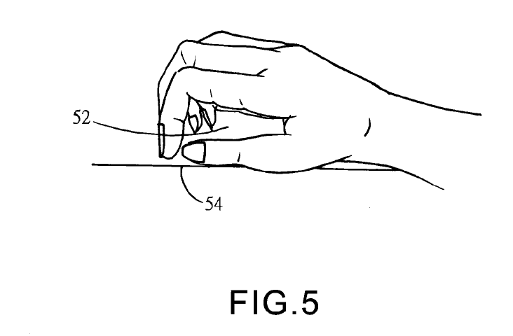

To achieve the method, a computer peripheral input device, also an ergonomic mouse is provided in a second embodiment. FIG. 3 is a schematic view of a computer peripheral input device according to the second embodiment of the present invention. FIG. 4 is a side view of the computer peripheral input device of FIG. 3. Referring to FIGS. 3 and 4, the computer peripheral input device may include a housing 11. The housing 11 may be positioned under the user's palm. The housing 11 may be shaped to prevent the user's palm from being humped when the user grips the housing 11 to operate the computer peripheral input device under the user's palm. Without this hump, the user may naturally positions the user's hand on a flat surface during the computer peripheral input device is operated.

Therefore, this shape of the housing 11 may protect the palm, the tendons of user's fingers, and the tendons of user's fingers from being injured.

When a user naturally positions the user's hand on a flat surface 54, a space 52 may forms under the user's palm, as shown in FIG. 5. Return to FIG. 3 and FIG. 4, the above-mentioned housing 11 is preferably shaped to have a size a little bit smaller than the size of the space 52 (FIG. 5) under the user's palm. Additionally, the housing 11 preferably has a shape without a protuberance thereon. The protuberance may hump the user's palm during the computer peripheral input device is operated.

The computer peripheral input device may further include at least one button 12. The button 12 may be sideward positioned on the housing 11. The position is for the user to non-downward push with the user's index finger or middle finger. This position is achieved by, for example, locating the button 12 on a substantially vertical plane 14 of the housing 11.

The vertical plane 14 and a bottom surface 16 of the housing may have an angle greater than about 90 degrees and smaller than about 125 degrees. The angle may alternatively be in the range of about 80 degrees to about 90 degrees, and more preferably about 90 degrees.

The above-mentioned angle is preferably not too small. For example, the angle is preferably not about 45 degrees. In this case of 45 degrees, a counterforce is obviously generated up to the user's palm, thereby forcing the user's palm as if it is humped. The counterforce may be a reason why the palm, the tendons of user's fingers, and the tendons of user's fingers are easily injured during a conventional computer mouse is operated.

On the other hand, the above-mentioned hump may be another reason why the palm, the tendons of user's fingers, and the tendons of user's fingers are easily injured, the shape of the housing 11, without any protrude, may protect the palm, the tendons and the tendons from being injured.

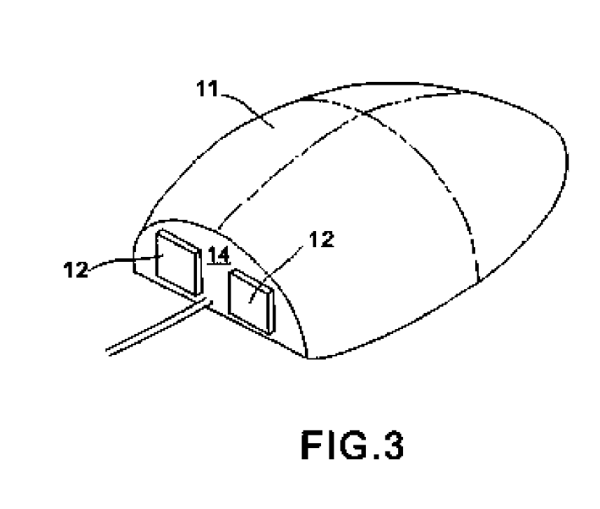

A third preferred embodiment of the present invention provides a computer mouse. Referring to FIG. 2, the computer mouse may include a mouse housing 1 and at least one button 2. The at least one button 2 is positioned on a front side of the mouse housing 1. By doing so, a user's finger may be naturally incurved from the front toward the back of the mouse housing 1 to press the at least one button 2 when the user's palm grips the mouse housing 1.

According to the third preferred embodiment, the present invention prevents a mouse's user from using his wrist to support his palm and fingers. Such support injures his tendon. Without the support, a nerve of the tendon may not be compressed. Moreover, an extensive force from the support is not generated through the user's meridian to injure the user's arm and back.

Obviously, many modifications and variations are possible in light of the above teachings. It is therefore to be understood that within the scope of the appended claims the present invention can be practiced otherwise than as specifically described herein. Although specific embodiments have been illustrated and described herein, it is obvious to those skilled in the art that many modifications of the present invention may be made without departing from what is intended to be limited solely by the appended claims.

What is claimed is:

1. A computer peripheral input device, comprising:
a housing under a user's palm; and
a button, sideward positioned on the housing, for the user to non-downward push with the user's index finger or middle finger.

2. The computer peripheral input device according to claim 1, wherein the housing does not hump a user's palm when the user grips the housing under the user's palm.

3. An ergonomic mouse, comprising:
a housing not humping a user's palm when the user grips the housing under the user's palm; and
a button, sideward positioned on the housing, for the user to non-downward push with the user's index finger or middle finger.

4. A method of using a computer mouse under a user's palm, comprising:
non-downward pressing a button sideward positioned on the computer mouse, with the user's index finger or middle finger.

5. The computer peripheral input device according to claim 4, wherein the housing does not hump a user's palm when the user grips the housing under the user's palm.
